(19) United States
(12) Patent Application Publication
(10) Pub. No.: US 2020/0096466 A1
(43) Pub. Date: Mar. 26, 2020

(54) RF SENSOR DEVICE FOR A VEHICLE AND METHOD OF ANALYZING FUEL COMPONENT USING THE SAME

(71) Applicants: HYUNDAI MOTOR COMPANY, Seoul (KR); KIA MOTORS CORPORATION, Seoul (KR); JEJU NATIONAL UNIVERSITY INDUSTRY-ACADEMIC COOPERATION FOUNDATION, Jeju-si (KR)

(72) Inventors: Jin Ha LEE, Seoul (KR); Yun Sang JEONG, Seoul (KR); Jeehyun LEE, Seoul (KR); Chong Hyun LEE, Jeju-si (KR)

(73) Assignees: HYUNDAI MOTOR COMPANY, Seoul (KR); KIA MOTORS CORPORATION, Seoul (KR); JEJU NATIONAL UNIVERSITY INDUSTRY-ACADEMIC COOPERATION FOUNDATION, Jeju-si (KR)

(21) Appl. No.: 16/206,520

(22) Filed: Nov. 30, 2018

(30) Foreign Application Priority Data
Sep. 21, 2018 (KR) 10-2018-0113758

(51) Int. Cl. G01N 27/22; G01F 23/26; G01F 23/28

(52) U.S. Cl. CPC G01N 27/221; G01F 23/28; G01F 23/266

(57) ABSTRACT

An RF sensor device for a vehicle is provided. The RF sensor device includes a patch type RF sensor including a first patch sensor attached to an outside of a fuel tank and a second patch sensor attached to the outside of the fuel tank to face the first patch sensor, and a function generator for connecting the first patch sensor and the second patch sensor through a ground patch and function converting the electrical signals of the fuel contained in the fuel tank detected by the first patch sensor and the second patch sensor.

### CROSS-REFERENCE TO RELATED APPLICATION

The present application claims priority to and the benefit of Korean Patent Application No. 10-2018-0113758 filed on Sep. 21, 2018, which is incorporated herein by reference in its entirety.

### FIELD

The present disclosure relates to an RF (Radio Frequency) sensor device for a vehicle and method of analyzing fuel component using the same. More particularly, the present disclosure relates to an RF sensor device for a vehicle which detects a specific resonance frequency according to an inherent permittivity of the fuel and method of analyzing the fuel component using the same.

### BACKGROUND

The statements in this section merely provide background information related to the present disclosure and may not constitute prior art.

As an RF signal passes through the material between the two antennas, there is a specific resonance frequency that minimizes the reflection coefficient (dB) according to the inherent permittivity of the material. All objects have inherent dielectric constants. Gasoline, diesel, kerosene, heavy oil and other automotive fuels also have inherent permittivity. Therefore, when the fuel is placed between the RF sensors, the RF sensor has its own resonance frequency depending on the permittivity of the fuel.

Also, when the air and the specific fuel are in the RF sensor, the overall permittivity changes depending on the amount of air. Therefore, depending on the amount of air, the RF sensor has its own resonance frequency.

Meanwhile, there are various methods for discriminating the kind and harmfulness of the fuel. Conventionally, there is a method in which additives are added to a fuel to investigate the components of the fuel using a chemical reaction, the type of the fuel is determined by using an inverse scattering signal of ultrasonic waves, or a method in which the sensor is directly contacted with the fuel.

When using chemical reactions, adding a chemical sample to check the condition of the fuel is very complicated and costly. When an inverse scattering signal is used, since there is an indirect method, a fuel having the same reverse scattering power cannot be distinguished from its original limit.

Therefore, these methods cannot be applied to actual automobiles due to problems of cost, difficulty in analyzing the size of the equipment, and time required to install fuel in the vehicle.

Accordingly, the conventional sulfur-containing fuel of each refiner cannot be reflected in the existing automobile, especially in the diesel vehicle, and the sulfur content of the total amount of fuel used for the operation at a certain distance is determined as a post-treatment catalyst of the total amount.

As a result, the desulfurization engine control is performed so as to recognize more or less of the sulfur content in the sulfur content than the actual sulfur content and to recover the performance deterioration due to sulfur poisoning of the post-treatment catalyst.

For this reason, the desulfurization control of the post-treatment catalyst causes deterioration of fuel consumption, deterioration of post-treatment catalyst, and deterioration of performance.

### SUMMARY

It is an aspect of the present disclosure to provide an RF sensor device for a vehicle and method of analyzing fuel component using the same for detecting a specific type of fuel or a substance in a fuel by detecting an inherent resonance frequency responsive to a specific dielectric constant of the fuel using the RF sensor. The present disclosure provides a method of analyzing a fuel component using an RF sensor for an vehicle used for optimization of desulfurization combustion control of an engine and maintenance of catalyst performance.

An RF sensor device for a vehicle in some forms of the present disclosure includes a patch type RF sensor including a first patch sensor attached to an outside of a fuel tank and a second patch sensor attached to the outside of the fuel tank to face the first patch sensor, and a function generator for connecting the first patch sensor and the second patch sensor through a ground patch and function converting the electrical signals of the fuel contained in the fuel tank detected by the first patch sensor and the second patch sensor.

Meanwhile, the RF sensor device for a vehicle in some forms of the present disclosure may further include a monopole type RF sensor including a plate patch attached to one side of the fuel tank and a probe connected to the plate patch and penetrating the inside of the fuel tank to be infiltrated with the fuel.

A standard fuel space including a standard fuel may be formed in the fuel tank, and an end of the probe may be positioned in the standard fuel space.

The function generator may connect the plate patch and the probe to function convert the electrical signal of the standard fuel detected by the plate patch and the probe.

Meanwhile, a method of analyzing fuel component using an RF sensor device for a vehicle in some forms of the present disclosure includes injecting a new fuel into a fuel tank containing the fuel and mixing the existing fuel with the new fuel, measuring a resonance frequency for the mixed fuel using an RF sensor device, measuring a resonance frequency for the mixed fuel using an RF sensor device, determining whether the mixed fuel is a normal fuel through the comparison, maintaining the engine combustion pattern corresponding to the standard fuel if it is determined that the mixed fuel is normal fuel, and operating reflecting an engine combustion control.

The method of analyzing fuel component in some forms of the present disclosure may further include after determining whether the mixed fuel is normal fuel through the comparison, measuring the sulfur content included in the mixed fuel if it is determined that the mixed fuel is not normal fuel, and comparing the sulfur content of the measured mixed fuel with the sulfur content information of the standard fuel to derive the difference, and adjusting the desulfurization timing of the catalyst when the mixed fuel is injected.

Meanwhile, the method of analyzing fuel component in some forms of the present disclosure may further include determining whether the temperature of the outside air is above zero if it is determined that the mixed fuel is normal fuel, maintaining the engine combustion pattern corresponding to the standard temperature and the standard fuel if it is determined that the temperature of the outside air is above zero, and operating reflecting an engine combustion control.

Meanwhile, the method of analyzing fuel component in some forms of the present disclosure may further include after determining whether the temperature of the outside air is above zero, determining the stability of the engine combustion if it is determined that the temperature of the outside air is not above zero, and notifying that the fuel is defective and alert the fuel if it is determined that the engine combustion is an abnormal combustion.

Meanwhile, the method of analyzing fuel component in some forms of the present disclosure may further include after determining whether the mixed fuel is a normal fuel through the comparison, determining whether the temperature of the outside air is below zero if it is determined that the mixed fuel is not normal fuel, and determining the stability of the engine combustion if it is determined that the temperature of the outside air is not below zero, notifying that the fuel is defective and warning oiling if it is determined that the fuel is abnormal, and operating reflecting an engine combustion control if it is determined that the combustion is not an abnormal combustion.

Meanwhile, the method of analyzing fuel component in some forms of the present disclosure may further include after determining whether the temperature of the outside air is below zero, determining the engine combustion mode corresponding to the combustible fuel with the DI (drivability) value information of the measured fuel, if it is determined that the temperature of the outside air is below zero, and optimizing combustion and operating reflecting ambient environment and fuel characteristics.

In some forms of the present disclosure, the resonance frequency of the fuel is used to identify the kind of the fuel or the substance in the fuel and precisely distinguish the sulfur content of the diesel so that the post-treatment catalyst of the diesel engine car is poisoned by the sulfur component contained in the diesel, the cycle can be accurately judged, and the desulfurization cycle can be accurately determined.

Thereby, the desulfurization combustion control of the engine can be improved and the performance of the catalyst can be maintained.

In addition, it may be possible to distinguish between general gasoline of gasoline engine vehicle and hi drivability gasoline to optimize engine combustion according to the corresponding fuel.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view schematically showing a patch type RF sensor of an RF sensor device for a vehicle in one form of the present disclosure installed in a fuel tank.

FIG. 2 is a view schematically showing a state which a patch type RF sensor and a monopole type RF sensor of an RF sensor device for a vehicle in one form of the present disclosure are installed in a fuel tank at the same time.

FIG. 3 is a diagram illustrating a design example of a patch type RF sensor in one form of the present disclosure.

FIG. 4 is a diagram illustrating a design example of a monopole type RF sensor in one form of the present disclosure.

FIG. 5 is a graph showing a change in resonance frequency measured by a patch type RF sensor in one form of the present disclosure, with respect to the mixing ratios of general commercial diesel and ship oil (inherent sulfur).

FIG. 6 is a graph showing a resonance frequency and an average resonance frequency measured several times by a patch type RF sensor in one form of the present disclosure, for each mixing ratio of a common commercial diesel and a marine oil (inherent sulfur).

FIG. 7 is a graph showing changes in resonance frequency measured by a patch type RF sensor in one form of the present disclosure, according to oil refiner of a general commercial diesel.

FIG. 8 is a graph showing the resonance frequency and the average resonance frequency measured several times by the patch type RF sensor in one form of the present disclosure, by refiners of the general commercial diesel.

FIG. 9 is a graph showing the resonance frequency and the average resonance frequency measured several times by the patch type RF sensor in one form of the present disclosure, by refiners of the general commercial diesel.

FIG. 10 is a flowchart showing a method of analyzing a fuel component using an RF sensor device for a vehicle in one form of the present disclosure.

FIG. 11 is a flowchart showing a method of analyzing a fuel component using an RF sensor device for a vehicle in one form of the present disclosure.

The drawings described herein are for illustration purposes only and are not intended to limit the scope of the present disclosure in any way.

### DESCRIPTION OF SYMBOLS

| | |
|---|---|
| 110: patch type RF sensor | 112: first patch sensor |
| 114, 118: ground patch | 116: second patch sensor |
| 120: function generator | 130: acryl plate |
| 140: monopole type RF sensor | 142: plate patch |
| 144: probe | 150: standard fuel space |

### DETAILED DESCRIPTION

The following description is merely exemplary in nature and is not intended to limit the present disclosure, application, or uses. It should be understood that throughout the drawings, corresponding reference numerals indicate like or corresponding parts and features.

The drawings are schematic, and are not illustrated in accordance with a scale. Relative dimensions and ratios of portions in the drawings are illustrated to be exaggerated or reduced in size for clarity and convenience, and the dimensions are just exemplified and are not limiting. In addition, same structures, elements, or components illustrated in two or more drawings use same reference numerals for showing similar features. It will be understood that when an element such as a layer, film, region, or substrate is referred to as being “on” another element, it can be directly on the other element or intervening elements may also be present.

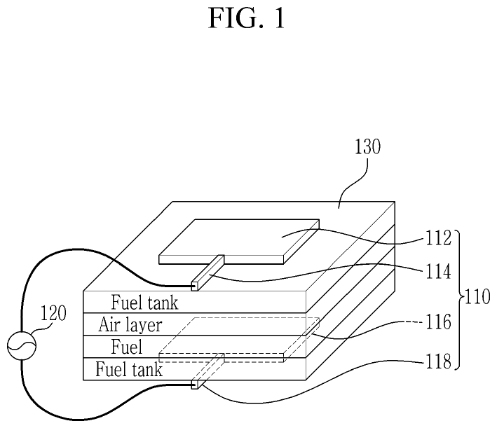

Now, an RF sensor for a vehicle in some forms of the present disclosure will be described with reference to FIGS. 1 to 4.

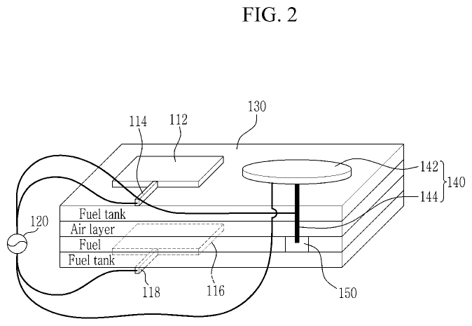

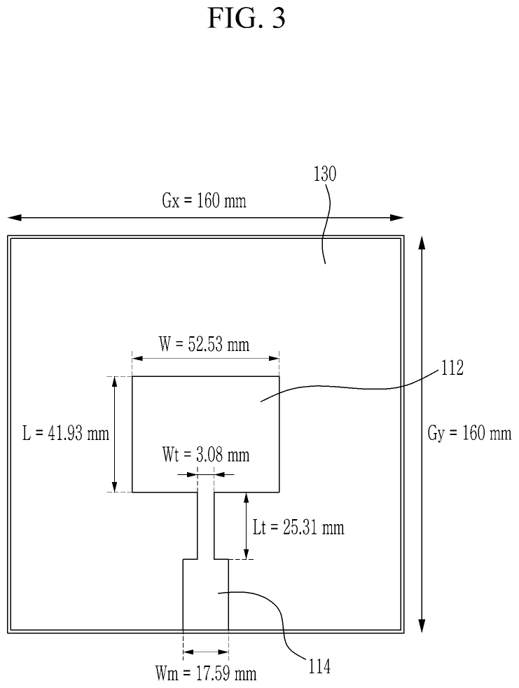

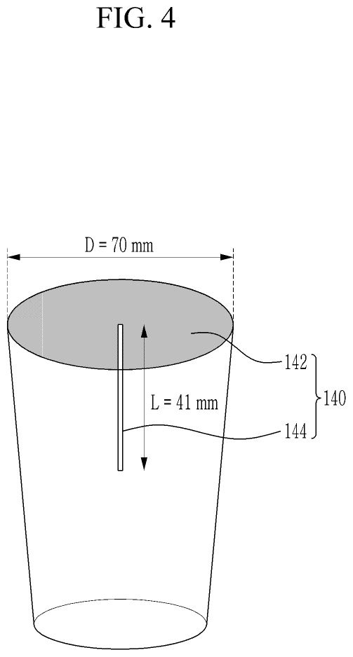

FIG. 1 is a view schematically showing a patch type RF sensor of an RF sensor device for a vehicle in some forms of the present disclosure installed in a fuel tank, FIG. 2 is a view schematically showing a state which a patch type RF sensor and a monopole type RF sensor of an RF sensor device for a vehicle in some forms of the present disclosure are installed in a fuel tank at the same time, FIG. 3 is a diagram illustrating a design example of a patch type RF sensor in some forms of the present disclosure, and FIG. 4 is a diagram illustrating a design example of a monopole type RF sensor in some forms of the present disclosure.

Referring to FIG. 1, an RF sensor device for a vehicle in some forms of the present disclosure includes a patch type RF sensor 110 including a first patch sensor and a second patch sensor 116 and a function generator 120.

The first patch sensor 112 of the patch type RF sensor 110 may be attached to an outside of a fuel tank, and the second patch sensor 116 may be attached to the outside of the fuel tank to face the first patch sensor 112.

The first patch sensor 112 and the second patch sensor 116 may be connected to the function generator 120 through ground patches 114 and 118. The function generator 120 may function convert the electrical signals of the fuel contained in the fuel tank detected by the first patch sensor 112 and the second patch sensor 116.

Meanwhile, a device for analyzing fuel component including the RF sensor device for a vehicle in some forms of the present disclosure may include a resonance frequency measuring unit 120 converting the signal obtained from the function generator 120 into a resonance frequency, a resonance frequency comparing unit for comparing the obtained resonance frequency with a resonance frequency inherent to the fuel, and a determination unit for determining the state of the fuel contained in the fuel tank according to the comparison result of the obtained resonance frequency and the resonance frequency inherent to the fuel.

The determination unit can discriminate whether the kind, quality and quality of the fuel and impurities or water or the like are infiltrated into the fuel tank by using the resonance frequency data inherent to the fuel. In addition, the sulfur content of the fuel can be determined using the fuel-specific resonance frequency and sulfur content data.

As shown in FIG. 3, the RF sensor 110 may be attached to the acrylic plate 130 and the acrylic plate 130 may be attached to the outside of the fuel tank. For example, the acrylic plate 130 may have a width Gx of about 160 mm and a length Gy of about 160 mm, and the lateral width W of the first patch sensor 112 and the second patch sensor 116 may be set to have a vertical width L of about 41.93 mm, and the ground patches 114 and 118 may be set to the shape, length, and width shown in FIG. 3.

Meanwhile, as shown in FIG. 2, an RF sensor device for a vehicle in some forms of the present disclosure may further includes a monopole type RF sensor 140 including a plate patch 142 attached to one side of the fuel tank and a probe 144 connected to the plate patch 142 and penetrating into the fuel tank to be infiltrated with fuel, unlike the patch type sensor 110.

The function generator 120 may function convert the electrical signal of the standard fuel detected by the plate patch 142 and the probe 144 by connecting the plate patch 142 and the probe 144.

A standard fuel space 150 including the standard fuel may be formed inside the fuel tank and an end of the probe 144 may be provided to be located in the standard fuel space 150. At this time, the standard fuel is a specific fuel with inherent permittivity, and is known to have a specific resonant frequency that minimizes the minimum reflection coefficient by a number of experiments. Standard fuels may be common commercial gasoline or common commercial gasoline fuels. In some forms of the present disclosure, the resonance frequency of the mixed fuel is measured and compared with the resonance frequency of the standard fuel to determine whether the mixed fuel is normal fuel.

As shown in FIG. 4, the monopole type RF sensor 140 may set the diameter D of the plate patch 142 to about 70 mm and the length L of the probe 144 to about 41 mm.

In some forms of the present disclosure, the patch type RF sensor 110 and the monopole type RF sensor 140 may be installed respectively or at the same time to outside the fuel tank to measure the resonance frequency of the fuel.

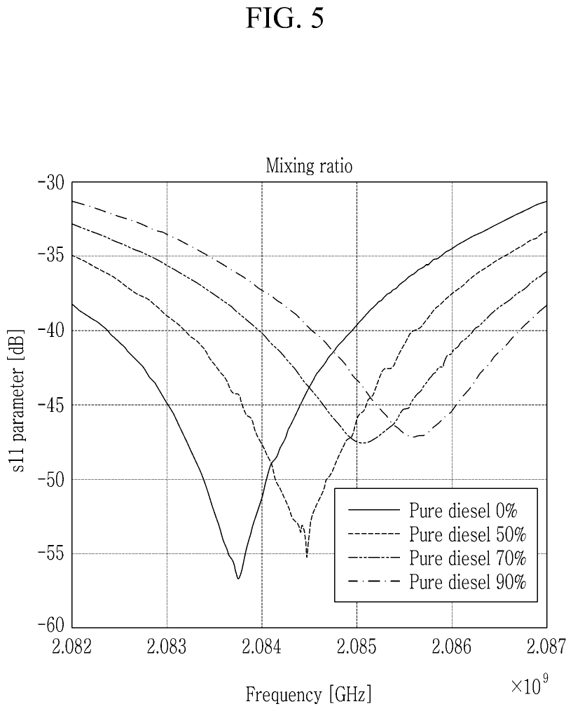

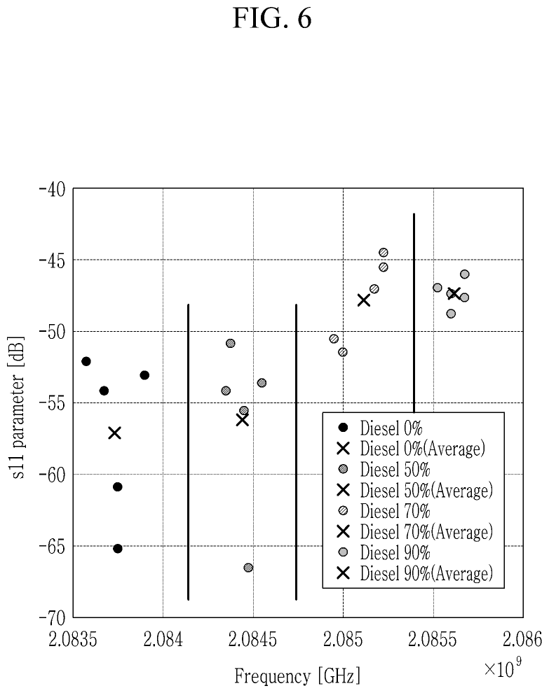

FIG. 5 is a graph showing a change in resonance frequency measured by a patch type RF sensor in some forms of the present disclosure, with respect to the mixing ratios of general commercial diesel and ship oil (inherent sulfur), and FIG. 6 is a graph showing a resonance frequency and an average resonance frequency measured several times by a patch type RF sensor in some forms of the present disclosure, for each mixing ratio of a common commercial diesel and a marine oil (inherent sulfur).

As shown in FIG. 5, when the pure diesel is 0%, the specific resonance frequency at which the reflection coefficient (s11 parameter) becomes minimum is about 2.08375 GHz, where the minimum reflection coefficient is about −56.75 dB. When the pure diesel is 50%, the specific resonance frequency is about 2.08447 GHz, where the minimum reflection coefficient is about −55.29 dB. When the pure diesel is 70%, the specific resonance frequency is about 2.08504 GHz, where the minimum reflection coefficient is about −47.58 dB. Further, when the pure diesel is 90%, the specific resonance frequency is about 2.08560 GHz, where the minimum reflection coefficient is about −47.21 dB. As described above, it can be confirmed that the resonance frequency at which the reflection coefficient becomes minimum varies depending on the sulfur content in the diesel.

As shown in FIG. 6, It is possible to derive the average resonance frequency at the minimum reflection coefficient by measuring the resonance frequency several times according to the mixing ratio of diesel and ship oil (inherent sulfur) by experiment.

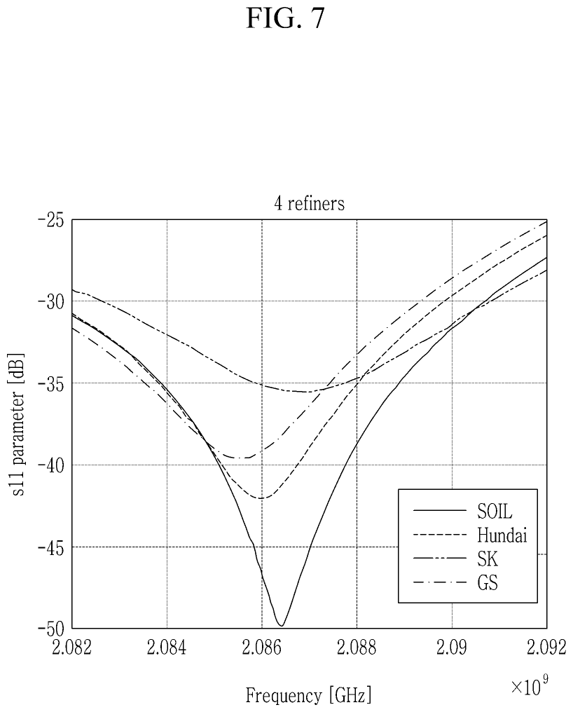

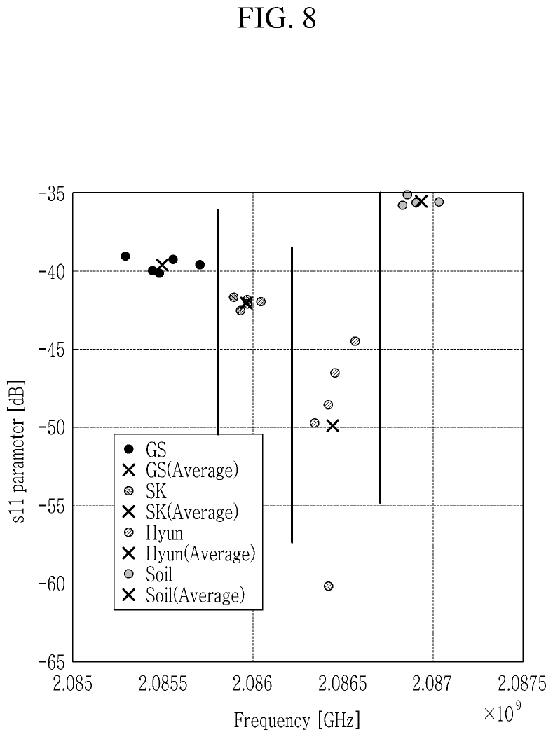

FIG. 7 is a graph showing changes in resonance frequency measured by a patch type RF sensor in some forms of the present disclosure, according to oil refiner of a general commercial diesel, and FIG. 8 is a graph showing the resonance frequency and the average resonance frequency measured several times by the patch type RF sensor in some forms of the present disclosure, by refiners of the general commercial diesel.

FIG. 7 and FIG. 8 show changes in the resonance frequency of refineries of general commercial diesel. In the case of GS company, the specific resonance frequency of diesel having the minimum reflection coefficient is about 2.08556 GHz, where the minimum reflection coefficient is about −39.59 dB. In the case of Hundai company, the resonant frequency of diesel is about 2.08597 GHz, and the minimum reflection coefficient is about −42.03 dB. In the case of Soil company, the resonant frequency of diesel is about 2.08642 GHz, and the minimum reflection coefficient is about −49.85 dB. Further, in the case of SK company, the resonant frequency of diesel is about 2.08642 GHz, and the minimum reflection coefficient is about −35.52 dB. Like this, it can be seen that the resonance frequency of the diesel with the minimum reflection coefficient for each refiner is different, and the sulfur content contained in diesel is different.

As shown in FIG. 8, the resonance frequency of the oil refiner and the diesel can be measured several times by experiments to derive the average resonance frequency of the diesel at the minimum reflection coefficient.

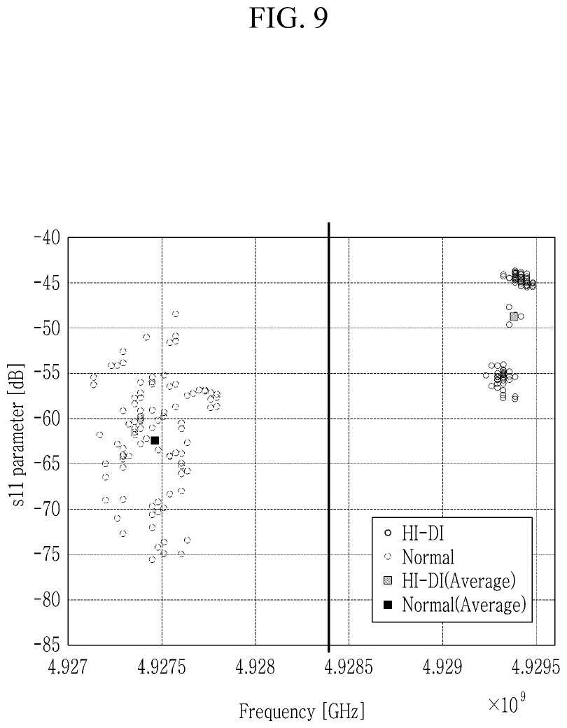

FIG. 9 is a graph showing the resonance frequency and the average resonance frequency measured several times by the patch type RF sensor in some forms of the present disclosure, with respect to the gasoline general fuel and the extreme high mileage gasoline fuel.

As shown in FIG. 9, the average resonance frequency of the gasoline general fuel with the minimum reflection coefficient is about 4.927 GHz and the average resonance frequency of the extreme high mileage gasoline fuel is about 4.929 GHz. and the resonance frequency difference between gasoline general fuel and extreme high mileage gasoline fuel is about 1.915 MHz. As described above, even in the case of gasoline fuel, the resonance frequency is different according to the difference of the dielectric constant, and the combustion can be optimized and operated according to the gasoline fuel type discriminated by the resonance frequency.

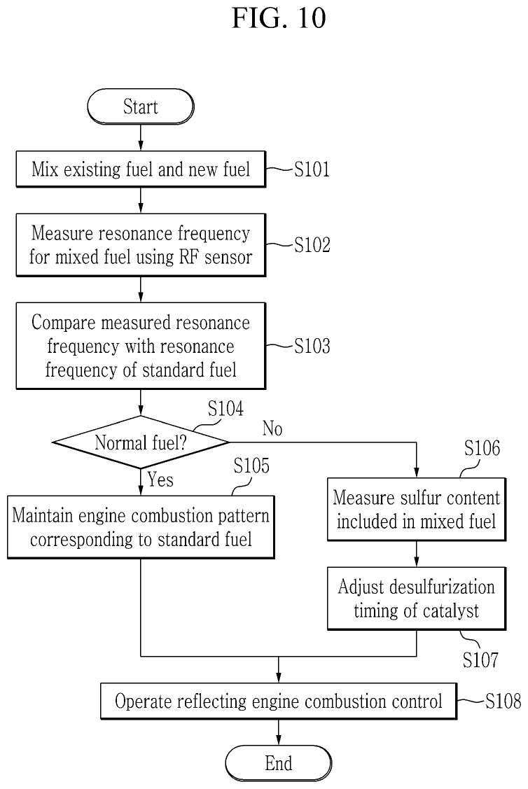

FIG. 10 is a flowchart showing a method of analyzing a fuel component using an RF sensor device for a vehicle in some forms of the present disclosure.

referring to FIG. 10, in a method of analyzing fuel component using an RF sensor device for a vehicle in some forms of the present disclosure, firstly, a new fuel is injected into a fuel tank containing the fuel and the existing fuel is mixed with the new fuel S101.

The existing and new fuels may be gasoline fuels. The existing fuels have inherent sulfur content, and if the sulfur content of the new fuel differs from the sulfur content of the existing fuel, the sulfur content of the mixed fuel after mixing the existing fuel with the new fuel will be different from the sulfur content of the existing fuel.

Then, a resonance frequency for the mixed fuel is measured using an RF sensor device S102. Diesel has inherent dielectric constant, and inherent resonance frequency is measured by the RF sensor according to the dielectric constant. The existing fuel has inherent dielectric constant and inherent resonance frequency, and mixed fuel has different dielectric constant from existing fuel, so resonant frequency different from existing fuel is measured.

Then, the measured resonance frequency is compared with a resonance frequency of a standard fuel S103. The resonance frequency of the standard fuel is measured by repeatedly measuring the resonance frequency of the existing fuel by an experiment using an RF sensor and then converting it into an average resonance frequency value.

Then, it is determined whether the mixed fuel is a normal fuel through the comparison S104. That is, it is determined whether the mixed fuel is the same as the standard fuel. If the new fuel is mixed with the existing fuel but shows the same resonance frequency as the standard fuel, the mixed fuel is determined to be normal. However, if the mixed fuel has a resonant frequency different from that of the standard fuel, the mixed fuel is determined to be an abnormal fuel.

Then, the engine combustion pattern corresponding to the standard fuel is maintained if it is determined that the mixed fuel is normal fuel S105.

Then, operation is performed reflecting an engine combustion control S108. The engine combustion control in the gasoline engine may be performed by adjusting the fuel injection amount and adjusting the ignition timing of the spark plug. For example, in the case of a multi-point injection (MPI) engine of a serial 4-cylinder type, the fuel injection amount increases when the fuel injection period is lengthened. In the case of a gasoline direct injection (GDI) engine that is a direct injection type gasoline engine, the injection amount can be increased by adjusting the period etc. Further, the ignition timing of the spark plug can be adjusted while advancing or retarding based on the peak of the engine piston.

Meanwhile, the sulfur content included in the mixed fuel is measured if it is determined that the mixed fuel is not normal fuel S106. It is determined that the sulfur content is 100% poisoned by the nitrogen oxide storage catalyst (LNT), the diesel oxidation catalyst (DOC) and the like when theoretically a fuel of 50 ppm or less is used. In this case, when SO2 or the like is measured at the downstream end of the catalyst, it is confirmed that the total amount is poisoned at 0 ppm. However, since the sulfur is slipped to the downstream end of the catalyst, the SO2 is measured at the downstream end of the catalyst.

Therefore, it is possible to measure the sulfur content contained in the mixed fuel from the SO2 detected by the SO2 detector and the mixed fuel consumption amount during the engine operation by providing the SO2 detector at the downstream of the LNT, DOC, etc.

Then, the sulfur content of the measured mixed fuel is compared with the sulfur content information of the standard fuel to derive the difference, and the desulfurization timing of the catalyst is adjusted when the mixed fuel is injected S107.

In the case of a standard fuel having a specific sulfur content, the desulfurization timing of the catalyst is set in advance according to the sulfur content, and the desulfurization timing of the catalyst can be adjusted according to the sulfur content contained in the mixed fuel.

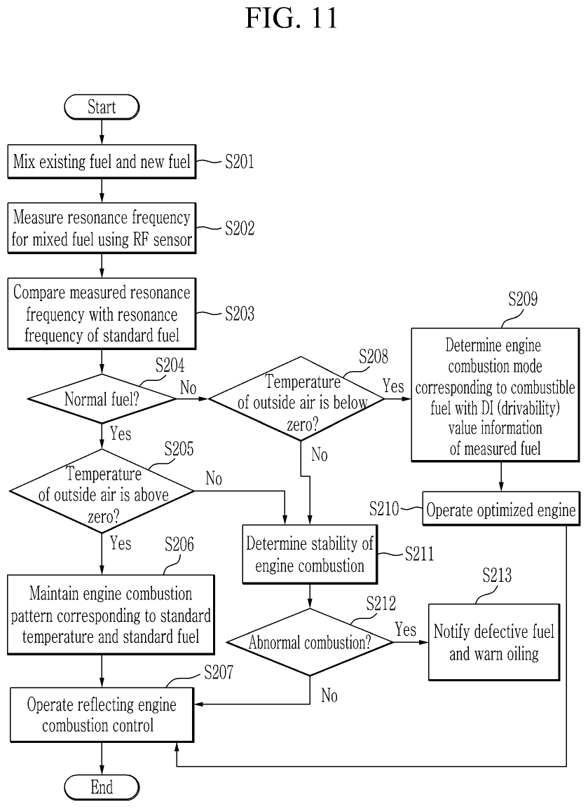

FIG. 11 is a flowchart showing a method of analyzing a fuel component using an RF sensor device for a vehicle in some forms of the present disclosure.

Referring to FIG. 11, in a method of analyzing fuel component using an RF sensor device for a vehicle in some forms of the present disclosure, firstly, a new fuel is injected into a fuel tank containing the fuel and the existing fuel is mixed with the new fuel S201. The existing and new fuels may be gasoline fuels.

Then, a resonance frequency for the mixed fuel is measured using an RF sensor S202. As shown in FIG. 9, general commercial gasoline fuels and extreme high mileage gasoline fuels have different resonant frequencies depending on their inherent dielectric constant. Further, the existing fuel has inherent dielectric constant and inherent resonance frequency, and mixed fuel has different dielectric constant from existing fuel, so resonant frequency different from existing fuel is measured.

Then, the measured resonance frequency is compared with a resonance frequency of a standard fuel S203. The resonance frequency of the standard fuel is measured by repeatedly measuring the resonance frequency of the existing fuel by an experiment using an RF sensor and then converting it into an average resonance frequency value. The resonance frequency of the standard fuel is data obtained by taking into account external environmental information (temperature, humidity) and characteristics of resonance frequency values of various commercial standard fuels and DI values of various fuels.

Then, it is determined whether the mixed fuel is a normal fuel through the comparison S204. That is, it is determined whether the mixed fuel is the same as the standard fuel. If the new fuel is mixed with the existing fuel but shows the same resonance frequency as the standard fuel, the mixed fuel is determined to be normal. However, if the mixed fuel has a resonant frequency different from that of the standard fuel, the mixed fuel is determined to be an abnormal fuel.

Then, it is determined whether the temperature of the outside air is above zero if it is determined that the mixed fuel is normal fuel S205.

Then, the engine combustion pattern corresponding to the standard temperature and the standard fuel is maintained if it is determined that the temperature of the outside air is above zero S206. At this time, the standard temperature means a normal temperature at which the standard fuel is formed when the mixed fuel is normal and the ambient temperature is image, when the standard fuel burns in the engine.

Then, operation is performed reflecting an engine combustion control S207. The engine combustion control in the gasoline engine may be performed by adjusting the fuel injection amount and adjusting the ignition timing of the spark plug. For example, in the case of an MPI engine of a serial 4-cylinder type, the fuel injection amount increases when the fuel injection period is lengthened. In the case of a GDI engine that is a direct injection type gasoline engine, the injection amount can be increased by adjusting the period etc. Further, the ignition timing of the spark plug can be adjusted while advancing or retarding based on the peak of the engine piston.

After determining whether the temperature of the outside air is above zero, the stability of the engine combustion is determined if it is determined that the temperature of the outside air is not above zero S211.

Then, it is determined whether the engine combustion is abnormal S212, and it is notified that the fuel is defective and warning oiling if it is determined that the fuel is abnormal S213. However, operating reflecting an engine combustion control is performed if it is determined that the combustion is not an abnormal combustion S207.

Meanwhile, after determining whether the mixed fuel is a normal fuel through the comparison S204, it is determined whether the temperature of the outside air is below zero if it is determined that the mixed fuel is not normal fuel S208.

Then, the stability of the engine combustion is determined if it is determined that the temperature of the outside air is not below zero S211, it is determined whether the engine combustion is abnormal S212, and it is notified that the fuel is defective and warning oiling if it is determined that the fuel is abnormal S213. However, operating reflecting an engine combustion control is performed if it is determined that the combustion is not an abnormal combustion S207.

At this time, the engine combustion mode corresponding to the combustible fuel is determined with the DI (drivability) value information of the measured fuel S209, and combustion and operating is optimized reflecting ambient environment and fuel characteristics S210.

Like this, in the method of analyzing fuel component in some forms of the present disclosure, it is possible to judge whether the mixed fuel injected into the fuel tank is normal quality and discriminate whether the fuel is general gasoline fuel or extreme high mileage gasoline fuel and correspondingly combustion optimization operation is possible.

Like this, in some forms of the present disclosure, the resonance frequency of the fuel is used to identify the kind of the fuel or the substance in the fuel and precisely distinguish the sulfur content of the diesel so that the post-treatment catalyst of the diesel engine car is poisoned by the sulfur component contained in the diesel, the cycle can be accurately judged, and the desulfurization cycle can be accurately determined.

Thereby, the desulfurization combustion control of the engine can be optimized and the performance of the catalyst can be maintained.

In addition, it is possible to distinguish between general gasoline of gasoline engine vehicle and hi drivability gasoline to optimize engine combustion according to the corresponding fuel.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An RF sensor device for a vehicle, comprising:
a patch type RF sensor comprising:
a first patch sensor attached to an outside of a fuel tank; and
a second patch sensor attached to the outside of the fuel tank to face the first patch sensor; and
a function generator configured to:
connect the first patch sensor and the second patch sensor through a ground patch; and
function-convert electrical signal of a fuel contained in the fuel tank detected by the first patch sensor and the second patch sensor.

2. The RF sensor device for the vehicle of claim 1, wherein the device further comprises:
a monopole type RF sensor comprising:
a plate patch attached to one side of the fuel tank; and
a probe connected to the plate patch, wherein the probe is configured to penetrate an inside of the fuel tank and to infiltrate the fuel.

3. The RF sensor device for the vehicle of claim 2, wherein:
a standard fuel space including a standard fuel is formed in the fuel tank, and
an end of the probe is positioned in the standard fuel space.

4. The RF sensor device for the vehicle of claim 3, wherein:
the function generator is configured to:
connect the plate patch and the probe; and
function-convert an electrical signal of the standard fuel detected by the plate patch and the probe.

5. A method of analyzing a fuel component using an RF sensor device for a vehicle, comprising:
injecting a new fuel into a fuel tank containing the fuel and mixing an existing fuel with the new fuel;
measuring a resonance frequency for the mixed fuel using the RF sensor device;
comparing the measured resonance frequency with a resonance frequency of a standard fuel;
determining whether the mixed fuel is a normal fuel by comparing the measured resonance frequency with the resonance frequency of the standard fuel;
when the mixed fuel is determined to be the normal fuel, maintaining an engine combustion pattern corresponding to the standard fuel; and
operating with an engine combustion control.

6. The method of claim 5, wherein the method further comprises:
when the mixed fuel is determined not to be the normal fuel, measuring a sulfur content of the mixed fuel;
comparing the sulfur content of the mixed fuel with a sulfur content of the standard fuel to derive a difference; and
when the mixed fuel is injected, adjusting a desulfurization timing of a catalyst.

7. The method of claim 5, wherein the method further comprises:
when the mixed fuel is determined to be the normal fuel, determining whether an outside temperature is above zero;
when the outside temperature is determined to be above zero, maintaining the engine combustion pattern corresponding to a standard temperature and the standard fuel; and
operating with the engine combustion control.

8. The method of claim 7, wherein the method further comprises:
when the outside temperature is determined not to be above zero, determining a stability of an engine combustion; and
when the stability of the engine combustion is determined to be abnormal, notifying that the fuel is defective.

9. The method of claim 7, wherein the method further comprises:
when the mixed fuel is determined not to be the normal fuel, determining whether the outside temperature is below zero;
when the outside temperature is determined not to be below zero, determining the stability of the engine combustion;
when the fuel is determined to be abnormal, notifying that the fuel is defective; and
when the stability of the engine combustion is determined to be normal, operating with the engine combustion control.

10. The method of claim 9, wherein the method further comprises:
when the outside temperature is determined to be below zero, determining an engine combustion mode corresponding to a combustible fuel with a DI (drivability) value of the fuel; and
optimizing combustion by reflecting ambient environment and fuel characteristics.
